(19) United States
(12) Patent Application Publication
(10) Pub. No.: US 2012/0283864 A1
(43) Pub. Date: Nov. 8, 2012

(54) AUTOMATED CAST COIL EVALUATION SYSTEM

(75) Inventors: Necmi Dogan, Jackson, TN (US); Kyle Thomas Kapeller, McKenzie, TN (US); David C.R. Lewis, McKenzie, TN (US)

(73) Assignee: NORANDAL USA, INC., Franklin, TN (US)

(21) Appl. No.: 13/100,577

(22) Filed: May 4, 2011

(51) Int. Cl. G06F 19/00

(52) U.S. Cl. 700/106

(57) ABSTRACT

A method for evaluating a sheet comprising the steps of casting a sheet and automatically determining characteristics relating to at least one of thickness or shape of the sheet during or immediately after the casting step. The method includes automatically determining chemical composition of the sheet. The method further includes receiving an order for the sheet and retrieving, from a database, specifications based upon the order. Finally, the method includes automatically comparing the determined characteristics to the retrieved specifications to determine the suitability of the sheet for use with the order.

The present invention is directed to a system and method for automatically evaluating a coil and/or for scheduling use of the coil.

### BACKGROUND

Many existing coil casting facilities create coils of cast metals, such as aluminum, for use with particular job orders. Due to certain factors, such as defects in the casting process, variations in the quality of the raw materials, and variations in the composition of the alloy, the cast coil can be outside the specifications for its associated job order. In many existing system, such an off-specification coil is then treated as scrap, and another coil of metal must then be formed to meet the order. Alternately, in some cases the fact that the coil is off-specification remains undiscovered, thus causing the coil to be scrapped after the coil is further processed. Such a system leads to in efficiency in manufacturing, storage and order matching.

### SUMMARY

In one embodiment the present invention a system in which cast coils are evaluated as they are manufactured so that out-of-specification coils can be identified. The out-of-specification coils may then be able to be handled and/or further treated such that they can still be used to meet the particular order for which they were designed, or used for another order, thereby improving efficiency (such as by improving process efficiency by reducing strip breaks in the cold rolling process) and reducing waste. In particular, in one embodiment, the invention is a method for evaluating a sheet comprising the steps of casting a sheet and automatically determining characteristics relating to at least one of thickness or shape of the sheet during or immediately after the casting step. The method includes automatically determining chemical composition of the sheet. The method further includes receiving an order for the sheet and retrieving, from a database, specifications based upon the order. Finally, the method includes automatically comparing the determined characteristics to the retrieved specifications to determine the suitability of the sheet for use with the order.

### BRIEF DESCRIPTION OF DRAWINGS

FIG. 1 is a schematic representation of one embodiment of the evaluation/scheduling system for a coil as disclosed herein;

FIG. 1A is a cross section of FIG. 1 taken the direction of arrow 1A of FIG. 1;

FIG. 2 is a schematic representation of a scheduler;

FIG. 3 is a chart comparing certain grading standards for cast coils with the actual values for a particular coil;

FIG. 4 is a chart comparing certain grading standards for cast coils with the actual values for another coil;

FIG. 5 is a chart comparing customer specified standards for a particular job with the actual values for a particular coil and manufacturer-specified standards for the job;

FIG. 6 is a chart comparing certified manufacturer-specified standards for two jobs with actual values for a particular coil;

FIG. 7 is a chart illustrating disposition options for coils with varying composition; and

FIG. 8 is a chart illustrating disposition options for coils with particular defects.

### DETAILED DESCRIPTION

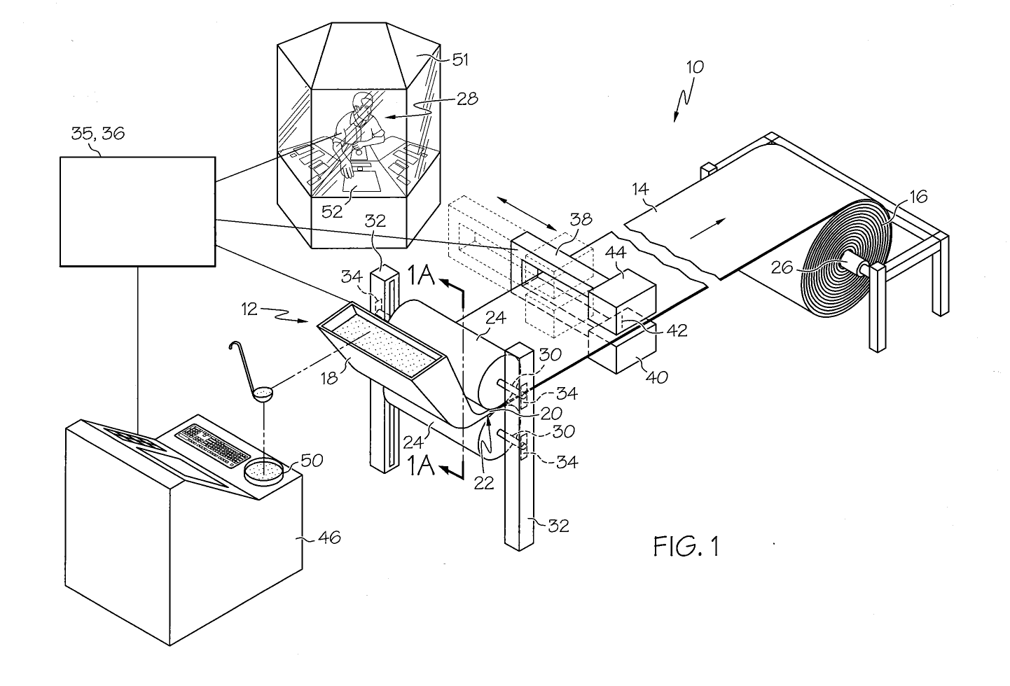

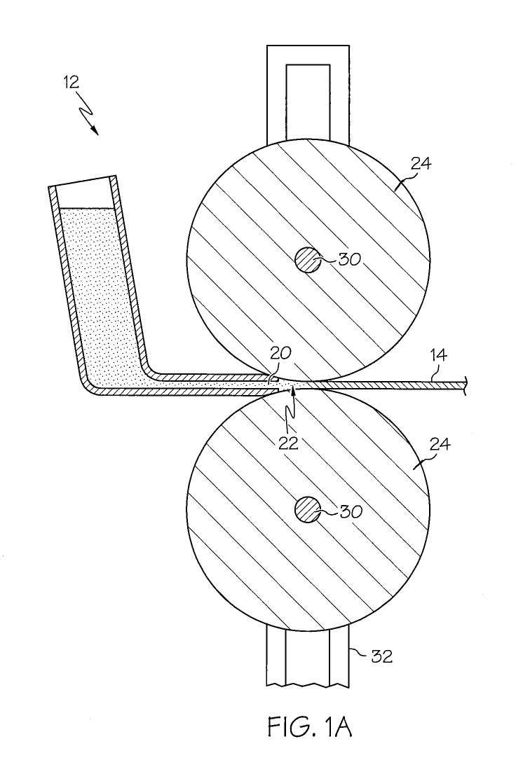

One embodiment of the system 10 includes, or is used in conjunction with, a casting machine or system 12 which is schematically represented in FIG. 1. The casting machine 12 is utilized to form a strip or sheet of metal 14 which is ultimately formed or rolled into a strip cast coil 16. However, the system 10 disclosed herein can be used with casting/rolling machines which can be used to form sheets/coils of any of a wide variety of materials, including metals (and more particularly, aluminum and aluminum alloys), plastic, paper, etc. However, the particular illustrative example of a strip cast coil 16 made of aluminum will be presented below.

In the particular schematic illustration shown in FIG. 1, the casting machine 12 includes a schematically-drawn hopper 18 which stores metal, or other material to be cast, in its molten state at or close to the desired composition for the alloy to be cast. Prior to being fed to the casting machine 12, the molten materials/metal may be fed to a holding furnace (not shown), passed through a de-gasser to remove gas, and fed through a filter to remove impurities from the molten material.

The hopper 18 terminates in a caster tip 20 which is positioned between the roll gap or roll bite 22 of a pair of caster rolls/rollers 24. In the illustrated embodiment each caster roll 24 is a generally horizontally aligned cylinder with the roll gap 22 positioned therebetween. However, the caster rolls 24 can be generally vertically aligned, or arranged at various angles relative to the horizontal. The caster rolls 24 are counter-rotated relative to each other as metal or other materials is fed into the roll gap 22. In this manner the sheet 14 is formed and passed in the downstream direction, away from the casting machine 12. The caster rolls 24 may be sprayed with a release coating, such as graphite, during casting operations so that the sheet 14 smoothly releases from the caster rolls 24. The sheet 14 can have a variety of thicknesses, such as between about 0.05″ and about 0.5″ in one case, and can have a variety of widths, such as between about 10″ and about 100″, in one case.

At the downstream end of the sheet 14, the sheet 14 is wrapped around a winder 26 (and itself) to form the strip cast coil 16. The coil 16 is wrapped/rotated at a predetermined speed/force to place the sheet 14 in tension as the sheet 14 is formed and cooled. An operator 28 of the casting machine 12 may be able to control the tension in the sheet 14 by adjusting the force/speed of the winder 26.

FIG. 1 is a schematic illustration of a particular casting machine 12 known as a TRC, or twin roll casting system. However, the system 10 disclosed herein can be used in conjunction with a wide variety of other casting machines or technologies for producing aluminum cast strips/coil, or other materials, including but not limited to twin-belt casters, direct chill casting system, including casting systems sold by Hazelett Strip Casting Corporation of Colchester Vermont, FATA Hunter Inc. of Riverside, Calif., and Pechiney Aluminum of Voreppe, France.

After the strip cast coil 16 is formed, the coil 16 may be stored or transported to another station for further processing. In many cases the coil 16 is fed to a milling operation where the coil 16/sheet 14 is passed through a pair of rollers under pressure to reduce the thickness/gauge of the coil 16/sheet 14, in a cold rolling process. In some cases the coil 16/sheet 14 is milled in this manner multiple times to reduce the thickness of the coil 16/sheet 14 to the desired end thickness.

The size of roll gap 22 determines the gauge or thickness of the sheet 14, and the casting machine 12 can control or adjust the roll gap 22 to thereby determine the gauge of the cast sheet 14 (for example, between about 0.05″ and about 0.5″ in one case). In particular, in the illustrated embodiment each caster roll 24 has a central axle 30 protruding outwardly from each axial end thereof, and each axle 30 is received in a post 32 which can adjust each axle 30 of one or both caster roll(s) 24 upwardly and/or downwardly. However, it should be understood that the illustrated system for adjusting the caster rolls 24 is merely a schematic representation, and the actual adjustment of the caster rolls 24 can take any of a wide variety of shapes and forms as known in the industry, including hydraulic adjustment systems or the like.

The system 10/casting machine 12 can also track the position of the caster rolls 24. In particular, the size of the roll gap 22 and/or distance between the axles 30 of the caster rolls 24 may be tracked. For example, the system 10/casting machine 12/caster rolls 24 may include, or be used in conjunction with, a sensor or plurality of sensors (schematically shown as sensors 34) to track the position of the caster rolls 24. In particular, when the position of the central axle 30/axis of each caster roll 24 is known/tracked, the size of the roll gap 22 can also be known/tracked since the shape and radius of the caster rolls 24 is known. Alternately, the size of the roll gap 22 can be tracked/determined by other methods, including directly measuring the roll gap 22.

It should be noted that the position of the caster rolls 24 has historically been tracked, if at all, only for maintenance/service purposes. However, as described in greater detail below, the present system 10 uses the position of the caster rolls 24/size of the roll gap 22 to track properties of the sheet 14/coil 16 being cast, and to determine how to best match the strip cast coil 16 with particular orders. The system 10/casting machine 12 may also track the rotational speed of the caster rolls 24, by any of a variety of speed sensors or the like. The rotational speed of the caster rolls 24 may also be able to be controlled by the operator 28 of the casting machine 12 as part of the casting operation.

The caster rolls 24, and more particularly the sensors 34 associated with the caster rolls 24, are operatively connected to an automated cast coil evaluation system 35 (termed “ACCES” herein), which is in turn operatively coupled to a scheduler 36, which allocates cast coils to orders. The ACCES system 35 and scheduler 36 can track the properties/characteristics of the sheet 14/coil 16. For example, the vertical position of the caster rolls 24, the size of the roll gap 22, and other inputs can be provided to the ACCES system 35 such that the characteristics of the sheet 14/coil 16 can be matched to the particular position along the length of the sheet 14/coil 16. In this manner, a representation of the gauge and/or gauge shifts of the entire sheet 14/coil 16 can be obtained and tracked from the caster rolls 24, and their sensors 34.

As further shown in FIG. 1, the system may include a radiometer 38 or other thickness-sensing instrument positioned adjacent to the sheet 14 which can determine characteristics relating to the thickness and/or shape of the sheet 14 (where “shape” can be considered to be an aggregation of thickness data to obtain understanding of the outer profile of the sheet 14). In the illustrated embodiment, the radiometer 38 includes an emitter 40, positioned on the bottom side of the sheet 14, which emits electromagnetic radiation 42 upwardly in a direction normal to the sheet 14. The radiometer 38 also includes a detector 44 positioned above the sheet 14 which receives the emitted radiation 42 after the radiation 42 has passed through the sheet 14. The radiometer 38 uses data relating to the emitted and sensed radiation to determine the thickness of the sheet 14 at that point.

In the illustrated embodiment, the radiometer 38 is movable in a lateral direction, perpendicular to the downstream travel of the sheet 14 (i.e. see FIG. 1 illustrating the radiometer 38 in two different positions). Continual lateral movement of the radiometer 38 in this manner, as the sheet 14 moves downstream, creates a “zigzag” scanning pattern across the surface of the sheet 14. The radiometer 38 can scan across the entire width of the sheet 14, or substantially the entire width of the sheet 14, as in some cases the radiometer 38 may be unable to scan the extreme outer lateral edges of the sheet 14. The radiometer 38 can accurately determine, or provide data that can be used to determine, the thickness of the sheet 14/coil 16 and also a variety of other characteristics of the sheet 14/coil 16, including crown, wedge, thickness, rut height, hump height, symmetry, swinging gauge, total gauge variation, sudden gauge change and gauge drop. The radiometer 38 can take the form of, for example, a Radiometrie™ Non-Contact Thickness Gauge System sold by Thermo Electron Corporation.

In one case, the radiometer 38 provides raw thickness data to processing software, such as LabVIEW™ software, sold by National Instruments Corporation of Austin, Tex., or other software, which processes the raw data to calculate, for example, average thickness of sheet center and edges, and in some cases standard deviation of such data. Such data may then be fed from the software to another system, such the ACCES system 35, which processes the received data to calculate, for example, average crown, average wedge, maximum rut height, maximum hump height, swinging gauge, symmetry, gauge drops, sudden gauge changes, total gauge variation and average center thickness. However, such data (or other desired data or measurements) can be measured and determined by any of a wide variety of systems and mechanisms.

The output of the radiometer 38 is ultimately provided to the scheduler 36. Since both the radiometer 38 and caster rolls 24 provide thickness data to the ACCES system 35/scheduler 36, the ACCES system 35/scheduler 36 may have an algorithm programmed therein to resolve differing thickness inputs from the radiometer 38 and caster rolls 24. However, the radiometer 38 and caster rolls 24 also provide differing type of data. In particular, as outlined above, the caster roll data may provide information relating to thickness across the entire width of the sheet 14/coil 16 at any given point in time, whereas the radiometer 38 typically provides thickness data at a single point in time. However, the radiometer 38 will generally provide more accurate data than the caster rolls 24, and can also provide additional data not provided by the caster roll data.

The system 10 of FIG. 1 also includes a device 46 for determining characteristics of the composition of the sheet 14/coil 16. In one embodiment, a sample of the molten metal/materials is retrieved with a ladle, spoon or the like (although any of a wide variety of systems and methods for obtaining a sample 50 can be utilized). The sample 50 is then burned on a spectrometer 46, such as an optical emission spectrometer or the like, which runs a test to determine the composition and chemical makeup of the metal forming the sheet 14/coil 16, such as volume/weight percentages of aluminum, other metals and elements. The time and rough/projected location of the sheet 14 at which the sample 50 is taken may be tracked, and this information is fed to the ACCES system 35/scheduler 36.

The system 10 may also include or utilize a human observer, such as the operator 28. As schematically shown in FIG. 1, the operator 28 can observe the sheet 14/coil 16 from an operator room 51 by cameras or directly by the naked eye as the sheet 14 is being cast and moved downstream. A human observer 28 can in some cases observe and detect defects not caught by the caster roll data, radiometer 38 and/or spectrometer 46. For example, the observer 28 may note the presence of edge cracks in the sheet 14, since the radiometer 38 may not scan the outer lateral edges of the sheet 14. The observer 28 may also be able note the presence of dips, holes, moisture lines on the surface of the sheet 14, or other visually detectable defects in the sheet 14. In some case the observer 28 is provided with a real-time electronic analysis of the casting process via a computer 52 or the like (i.e. output from the radiometer 38), which the observer 28 may use to log or enter his or her observations. In this manner, the particular defects, or other items of interest, can be tagged to a particular location of the sheet 14/coil 16 when the operator-observed information is provided to the scheduler 36.

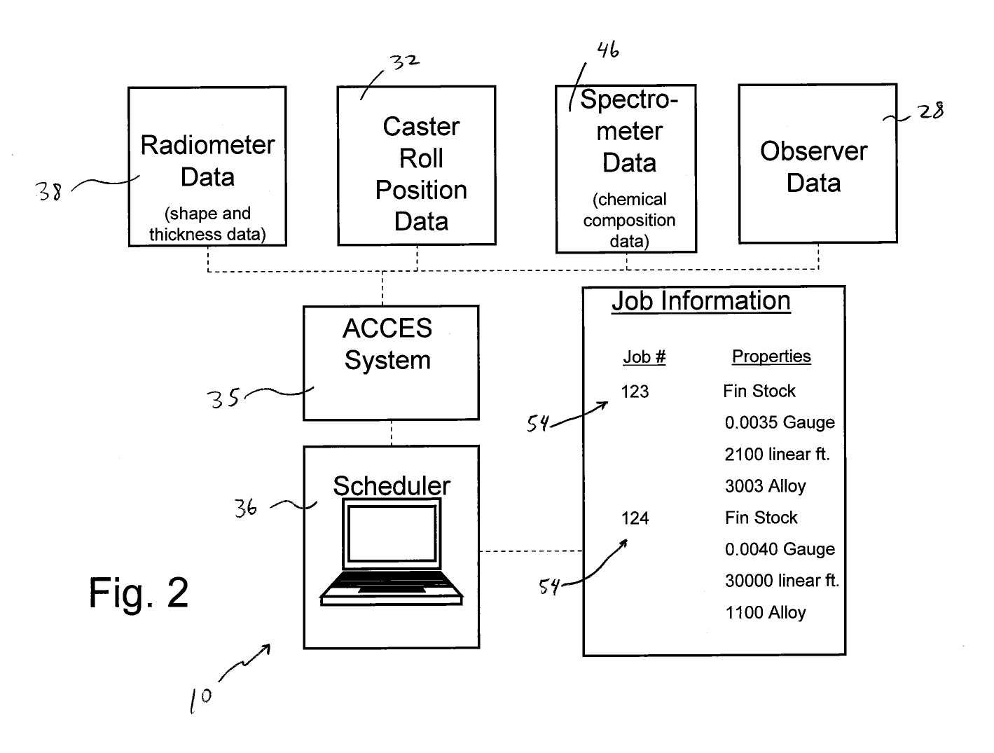

As noted above and can be seen in FIGS. 1 and 2, the output of the radiometer 38, caster roll sensors 34, spectrometer 46 and observer 28 are all fed to the ACCES system 35. The ACCES system 35, or an algorithm or associated computer/processor, may be configured to assign a grade to each sheet 14/coil 16 based upon the received input. In particular, the ACCES system 35 may store a plurality of threshold values or ranges therein for various properties of the sheet 14/coil 16, such as gauge/thickness (including average central thickness, central thickness standard deviation, driver side thickness standard deviation, and operator side thickness standard deviation), the position of the caster rolls 24 on both the operator side and drive side, and compare such thresholds to data received from or calculated off of data from the caster rolls 24 and/or radiometer 38. The ACCES system 35 may also store a plurality of threshold values or ranges therein for other properties of the sheet 14/coil 16 such as crown (including % average crown and crown standard deviation), wedge (including % average wedge and wedge standard deviation), rut height (including maximum rut height), hump height (including maximum hump height), symmetry, swinging gauge, total gauge variation, sudden gauge change, gauge drop and other values, compare such thresholds to data received from or calculated off of data from the radiometer 38. The ACCES system 35 may also store and compare a plurality of threshold values or ranges therein for properties of the sheet 14/coil 16 relating to chemical composition (i.e. from the spectrometer) 46, and visually recognizable inputs or flaw (i.e. from the operator 28).

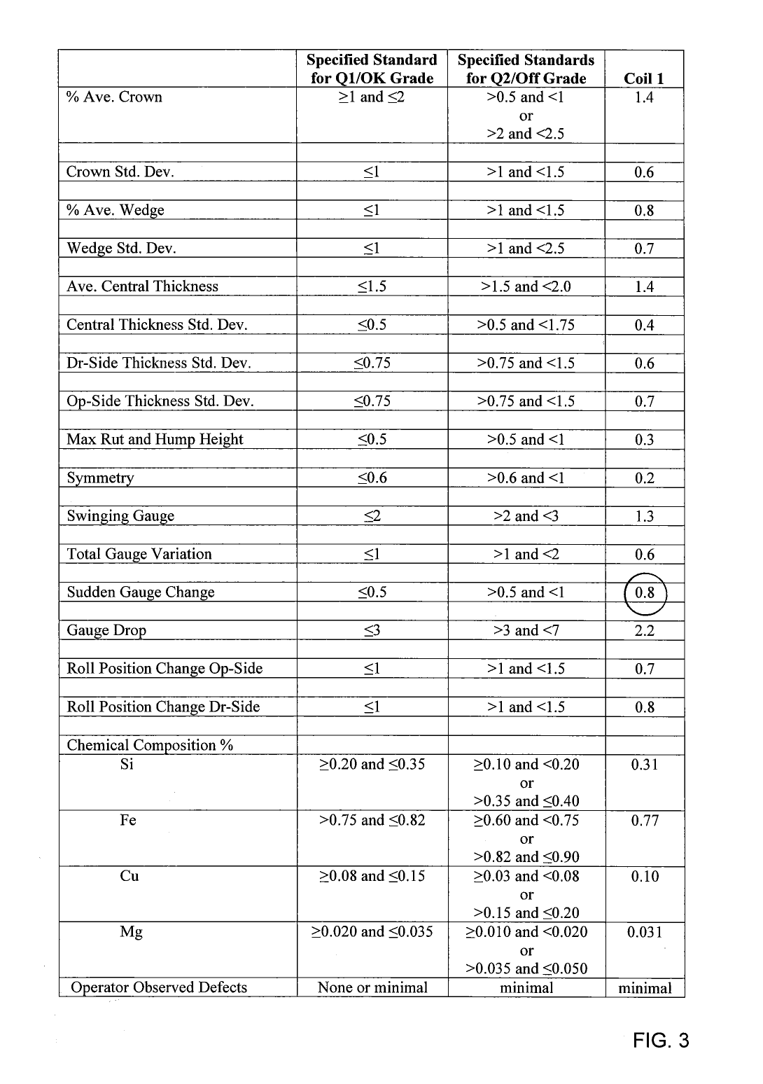

Each sheet 14/coil 16 may be assigned a grade, depending upon whether the qualities of the sheet 14/coil 16 meet or exceed the appropriate thresholds or ranges. The table of FIG. 3 provides an example, in the first column, of certain qualities, thresholds or ranges which qualify a coil as “Q1” based upon shape and “OK” based upon chemistry and/or visual properties if all of the qualities, thresholds and ranges are met. However, it should be understood that the values listed in the table of FIG. 3 (as well as the other tables provided herein) are provided merely for illustrative purposes and do not necessarily represent an actual grading system. The provided values and ranges provided herein are also generally unitless to emphasize the fact that such values are only illustrative.

In any case, if the cast coil meets all of the properties listed in the first column of FIG. 3, the coil may be assigned the Q1 grade based upon its shape (which, in the illustrated embodiment, is the highest grade). If one, or a sufficient number, of thresholds or ranges are not met, but the number of thresholds not met is relatively low, and/or the amount by which the thresholds are failed to be met is relatively low, then the coil may be assigned a shape lower grade (i.e., Q2; the second column in FIG. 3). The grading can take on as many gradations as desired, in one embodiment from Q1 down to Q5 or scrap. Similarly, if the cast coil meets all of the chemical composition properties and/or visual properties listed in the first column of FIG. 3, the coil may be assigned the OK grade for its chemistry and/or visual properties.

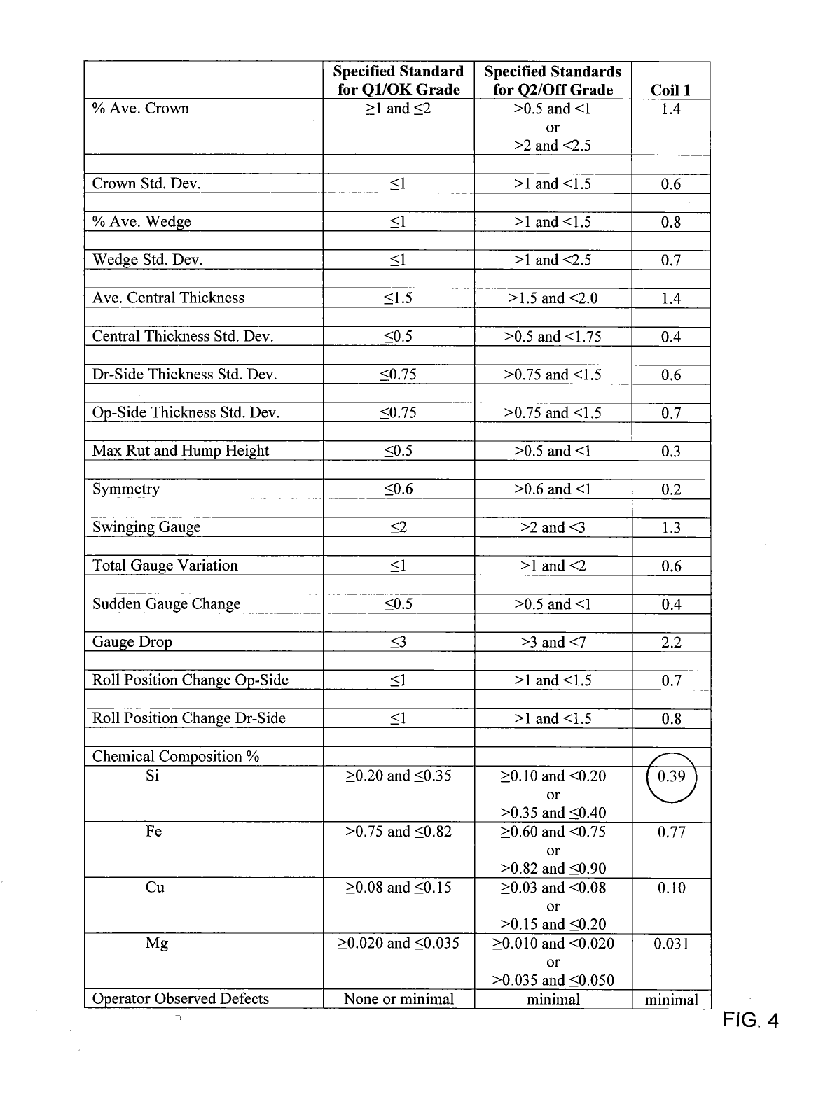

FIG. 3 illustrates a case in which the coil considered therein (Coil 1) does not qualify as a Q1 coil since its sudden gauge change (the circled value in FIG. 3) exceeds the parameters for a Q1 coil. However, the coil is graded Q2 since the circled value does not exceed the parameters for a Q2 coil. Similarly, the coil in FIG. 4 is graded or categorized as “off-grade” due to the silicon content of the coil. In evaluating the chemical content of a coil, the coil may be considered within grade or OK if the coil falls within the specified parameters, and off-grade or scrap if the coil falls outside the specified parameters. A coil graded off-grade may still be sufficient for use with other jobs, whereas a coil graded scrap may not be sufficient for use with any other jobs. Thus, in the illustrated embodiment, the Q1, Q2, Q3, Q4 and scrap designations may apply to the shape of the coil, and the OK, off-grade and scrap designation may apply to the chemistry of the coil.

The system 10, and more particularly the ACCES system 35, thus provides an automatic coil grading/evaluation system, which removes operator error and subjectivity. The use of caster roll position data 34 ensure that properties (such as gauge drop, sudden gauge change, swinging gauge, maximum rut height, maximum hump height, etc.) across the entire lateral width of the sheet 14/coil 16 are considered, and the use of radiometry data 38 ensures the use of highly accurate and diverse thickness and shape data. The radiometry data 38 can also be used to accurately calculate sudden gauge change, gauge drops, swinging gauge, symmetry, total gauge variation, % average wedge, % average crown, rut height, hump height, and average thickness. In addition, the use of the spectrometer 46 ensures that the grading/evaluation takes into account the chemical composition of the metal, and the human observer data ensures additional defects are noted.

The use of all such information from various sources ensures that a complete and accurate evaluation/grade of the coil 16 is achieved. In addition, the use of an automated coil evaluation system ensures that potentially troublesome characteristics are caught. For example, when merely using existing color-map review systems, the color-map may be at a sufficiently low resolution that a human observer of the color map may not see or notice a large change in gauge drop (or other features), which could be critical to the grade of the coil. The automated coil evaluation system described herein enables such statistical outliers to be caught, noted and taken into account. The automated cast coil evaluation system also enables the output of the casting operations to be tracked. For example, the effectiveness of a particular casting machine can be tracked (i.e. the % of cast coils which are Q1, Q2, OK, off-grade etc.), as well as the effectiveness of particular operators 28, which information can then be used as feedback to improve efficiency and effectiveness of the casting operations.

Besides enabling/providing the automatic grading feature, the ACCES system 35 also provides its data to the scheduler 36, which uses the data in scheduling uses of the coils 16. For example, as shown in FIG. 2, the scheduler 36 may be programmed to receive and/or store various job information, requests or orders 54 therein. Each job request 54 may specify a certain amount and quality (i.e. width, length, thickness, alloy or chemical composition, mechanical properties, associated tolerances, temper, market, grade, etc.) of material for use in a particular job. The job request 54 may also specify an end use for the material, such as fin stock, container stock, aluminum foil, etc. The scheduler 36 may also receive, or retrieve, certain properties associated with that job, such as minimum acceptable properties for the job, including gauge, crown, wedge, thickness, rut height, hump height, symmetry, swinging gauge, total gauge variation, sudden gauge change, gauge drop and roll position change, chemical composition, and other inputs.

In many existing systems, an incoming job 54 request may specify, or be assigned, a particular grade of material. The casting machine 12 may then be operated to cast a coil 16 that is at or exceeds the desired grade. If the cast coil 16 did not meet or exceed the desired grade, then the coil 16 would not be used for that job, and could be scrapped, leading to losses in material and time, or the defect(s) could go undetected, which would cause scrap and/or quality problems after further processing.

In contrast, the system 10/scheduler 36 described herein looks beyond the grade of material (if the grade is even considered at all) to examine particular properties of the coil 16 to determine whether the coil 16 is appropriate for the job, or if not, appropriate for another job. For example, a coil 16 may be cast for a job which specifies the material be Q1, but the cast coil is graded Q2. In this case, under the system 10 disclosed herein, the coil 16 is not necessarily automatically discarded. Instead, the scheduler 36 will examine the various properties of the coil 16 to determine whether the coil 16 is nevertheless suitable for the job.

For example, consider the case (in FIG. 3) where the only defect causing the coil to be graded as Q2 (instead of Q1) is the fact that the coil has an excessively large sudden gauge change (the circled value in FIG. 3). The scheduler 36 may examine the properties associated with the job, and determines that the sudden gauge change for that coil (0.8) is nevertheless acceptable for that job. In particular, the scheduler 36 may determine that the job has a relatively heavy or thick gauge such that the coil is only cold rolled for two passes; and that the coil is sufficiently thick that it will not break during the passes and will provide sufficient minimum thickness for the job. In this case the scheduler 36 may approve the coil for use with the job, or the scheduler 26 may assign the coil to another order that is compatible with the coil, thereby saving the coil from being scrapped, saving time and expense, and reducing the frequency of strip breaks during the cold rolling process. Moreover, even if the entire coil 16 is determined not to be suitable for use with a job, the scheduler may determine that a certain portion or percentage of the coil 16 is acceptable for use with the job. In addition, as described in greater detail below, if the coil 16 is determined to be unacceptable for use with that particular job, the system 10 may match the coil 16 with another job.

FIG. 4 illustrates another case in which the composition of the cast coil is out of range for that associated with the chemistry grade (as specified by the customer, for example) since the amount of silicon is too high (again, the circled value). However, the scheduler 36 may determine that the amount of silicon is nevertheless sufficient for that job, thereby enabling the coil to be used. For example the scheduler may know that the increased silicon slightly decreases the % elongation of the coil 16, but that the end use of the coil does not require high % elongation. Moreover, as described in greater detail below, if the coil 16 is determined to be unacceptable for use with that particular job, the system 10 may match the coil 16 with another job.

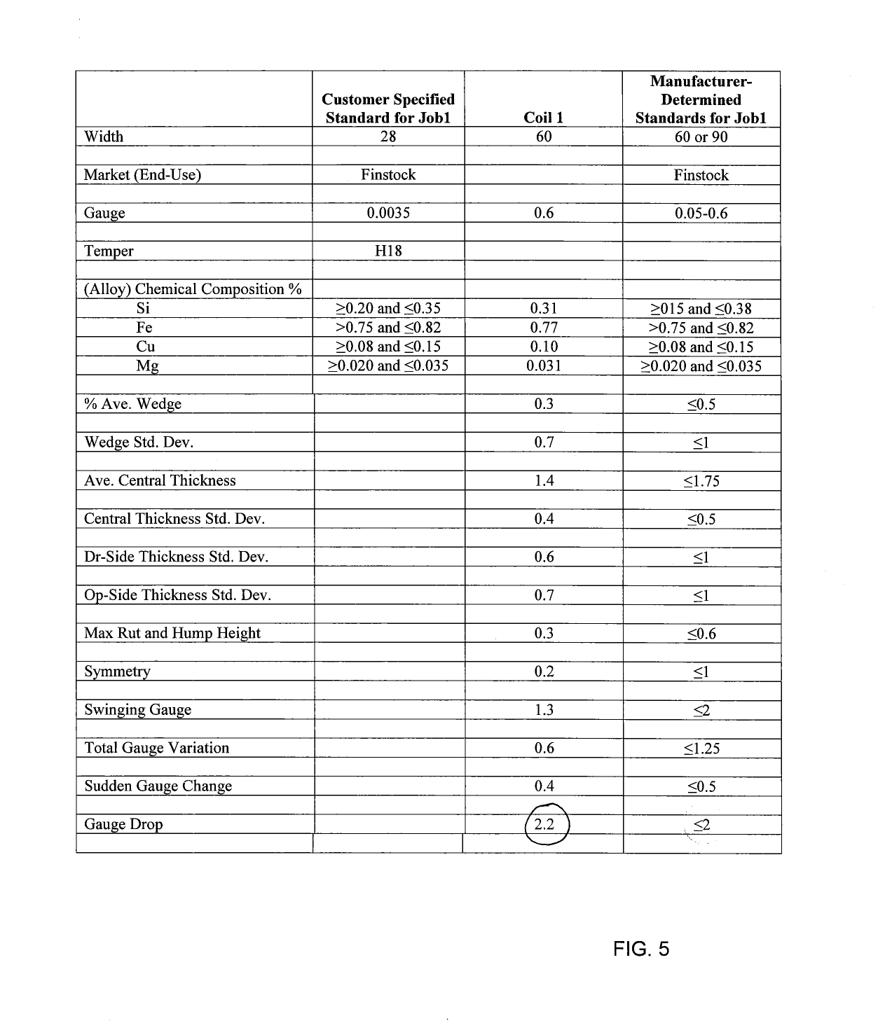

FIG. 5 more particularly illustrates the manufacturer-determined standards which may be used for a particular job. For example, the first column of FIG. 5 lists specified standards for a job (i.e. in one case, as received from a customer). The customer-listed standards can take any of a variety of forms, but often specify the width, market (i.e. end-use, such as fin stock, container stock, aluminum foil), gauge, temper, certain mechanical properties, and alloy (taking the form of chemical composition % listed in FIG. 5). Since the customer may not supply all of the standards which the manufacturer may use to grade or evaluate a coil 16, many of the values in the left-hand column of FIG. 5 are left blank.

The third column in FIG. 5 illustrates some manufacturer-supplied standards which may be provided or calculated by the manufacturer based upon the customer-supplied information. The standards specified in the third column can, but may not necessarily, correspond to standard Q1, Q2, etc. gradings. The third column represents the manufacturer's standards for the job, based upon the base standards supplied by the customer, and expanded upon by the manufacturer's knowledge and experience. This information thus essentially takes the form of a knowledge base, based upon experience, data, and/or calculations from the manufacturer or other sources, and determines the minimum and maximum acceptable thresholds for various properties of coils for use with specific jobs. Since the manufacturer-specified standards are more extensive and complete than those provided by the customer, the manufacturer-specified standards can more accurately judge the suitability of a coil for the customer.

The second column of FIG. 5 lists the actual physical properties of a particular coil. In the example shown in FIG. 5, it can be seen that the circled value (for gauge drop) exceeds the manufacturer's standards. Thus, the manufacturer, taking into account the end use of the coil and the other information provided by the customer, may determine that the coil is not acceptable for the customer's use, even though the specification which is exceeded is not provided by the customer, since the manufacturer may have greater experience in judging the suitability of the coil, and since the manufacturer has other information relating to the coil which the customer could not have. In this case, the final determination for acceptability of a coil may be based upon its suitability for its market or end-use, as determined by the manufacturer.

The manufacturer-specified standards may also, in some cases, differ from or even contradict those supplied by the customer. For example, the third row of FIG. 5 shows that that manufacturer has determined a differing range for amounts of silicon than that supplied by the customer. In this case, then a coil which might previously have been considered scrap, can be determined to be acceptable for use with the specified job under the current system.

The third column in FIG. 5, and all other information relating to acceptable standards for particular jobs, may be stored in or accessible by the scheduler 36. The knowledge base can continued to be expanded and build upon during operation of the system 10. For example, if the operator of the system 10 receives feedback from a customer that a coil, which was otherwise out of spec./grade for a job, nevertheless performed well, then the knowledge base/system can be updated with such feedback. Conversely, if the operator of the system 10 receives feedback from a customer that a coil, which was otherwise out of spec./grade for a job, or even within spec./grade, performed poorly, then the knowledge base/system can be updated to adjust the manufacturer-determined standards.

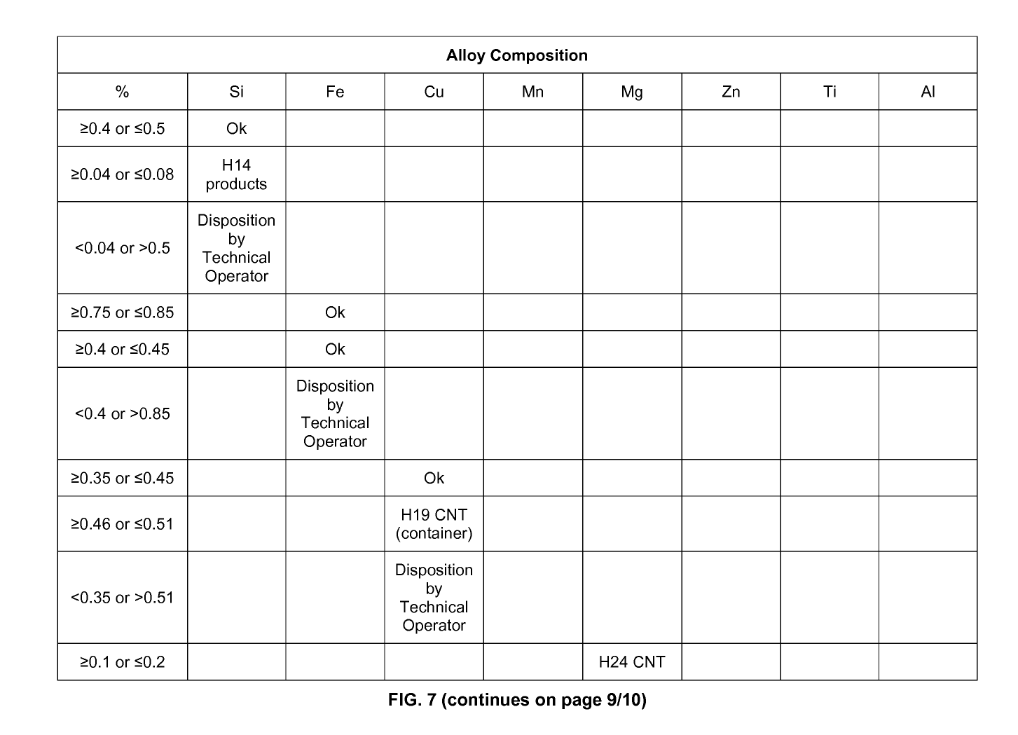

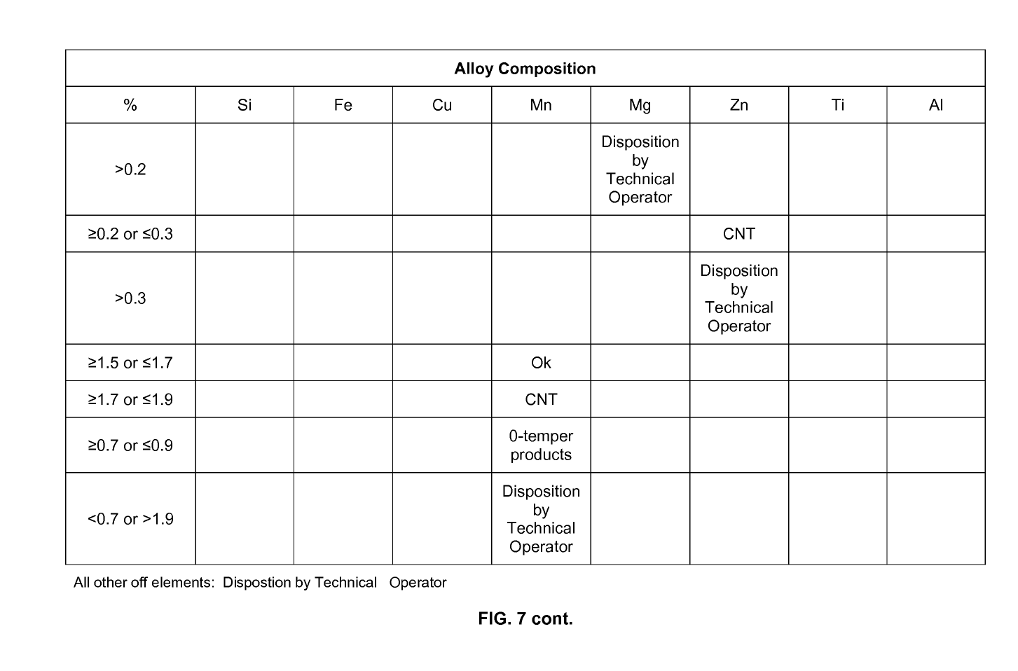

FIG. 7 shows, for example, data which may be stored in the database/knowledge base associated with acceptable amounts of elements in an alloy for particular jobs, and can be used as a guide for the handling of coils after they are cast. In particular, FIG. 7 shows that if a coil contains too much and/or too little of any particular element, the coil may nevertheless be able to be used for the associated job, or if not then can be used for certain other jobs as specified in the chart. For example, a coil evaluated under the chart of FIG. 7 may be designed to have a silicon percentage of between 0.4 and 0.5, as shown in the top-left box of the table. However, the box immediately below the top-left box shows that the coil may still be able to be used for a particular product (H14 products), if the silicon percentage is between 0.04 and 0.08. If the silicon percentage is less than 0.04 or greater than 0.5 (and not between 0.04 and 0.08), or otherwise outside the specified ranges, then the (human) technical operator needs to be consulted, and will determine disposition of the coil on a case-by-case basis.

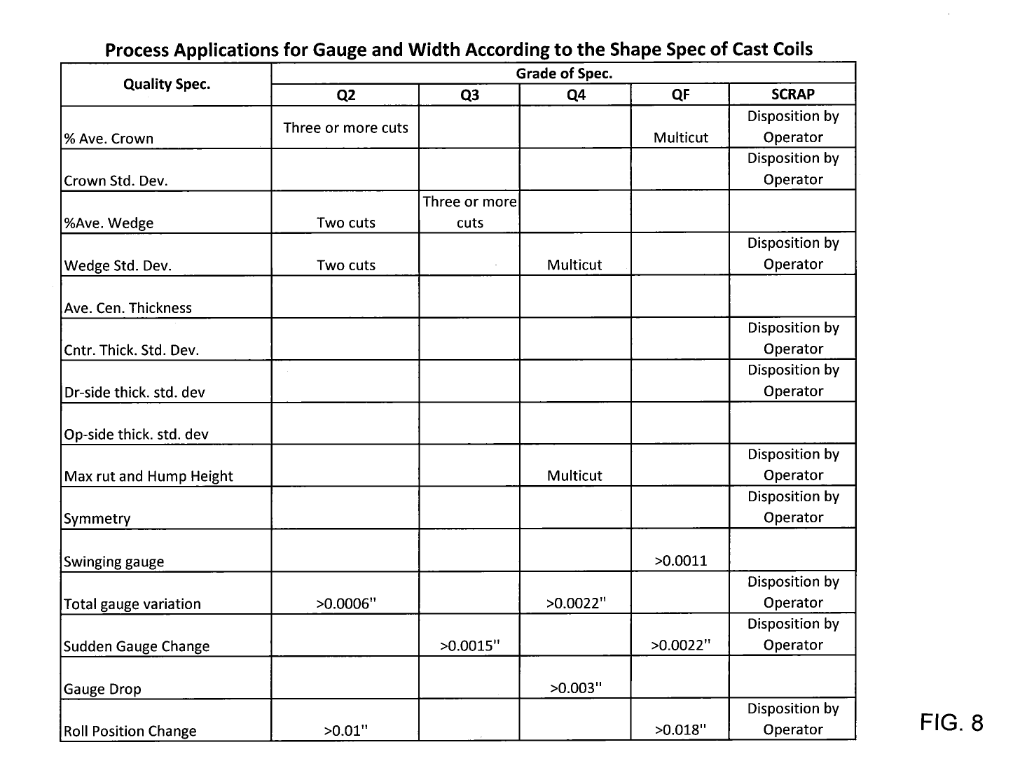

FIG. 8 shows another chart which may be used by the scheduler 36 to determine the disposition of coils after they are graded/evaluated, based upon shape/gauge properties of the coil. In the embodiment shown in FIG. 8, all of the specifications are based off of data from the radiometer 38, except the roll position change specification, which comes from the caster roll position data.

The chart of FIG. 8 provides dispositions based upon a particular property that causes the coil to be graded at that level. For example, as indicated in the top-left entry of the table of FIG. 8, a coil that is graded Q2 (instead of Q1), primarily due to the fact that its % average crown exceeds the specifications for Q1, may be deemed unsuitable for the particular job, but the coil may be able to be used in a job in which the coil is slit at least three times (i.e. longitudinally). However, as shown in the box immediately below, a coil that is graded Q2, primarily due to the fact that its crown standard deviation exceeds the specifications for Q1, may nevertheless be judged to be suitable for the job (since that entry in the table is blank). If the coil is graded Q2, primarily due to the fact that its total gauge variation exceeds the specifications for Q1, the coil can be used for jobs in which the gauge is greater than 0.0006 inches. As can be seen several boxes below, if the coil is graded Q4, primarily due to the fact that its gauge drop exceeds specifications, according to the table of FIG. 8 the coil can be used for jobs in which the gauge is greater than 0.003 inches. Thus, the numerical values in the table of FIG. 8 sets forth the minimal gauge of jobs the coil may be suitable for use with. The tables of FIGS. 7 and 8, therefore, set out illustrative scenarios in which a coil can be judged to be suitable for use with a particular job, and if judged to not be suitable, can be matched with other suitable jobs.

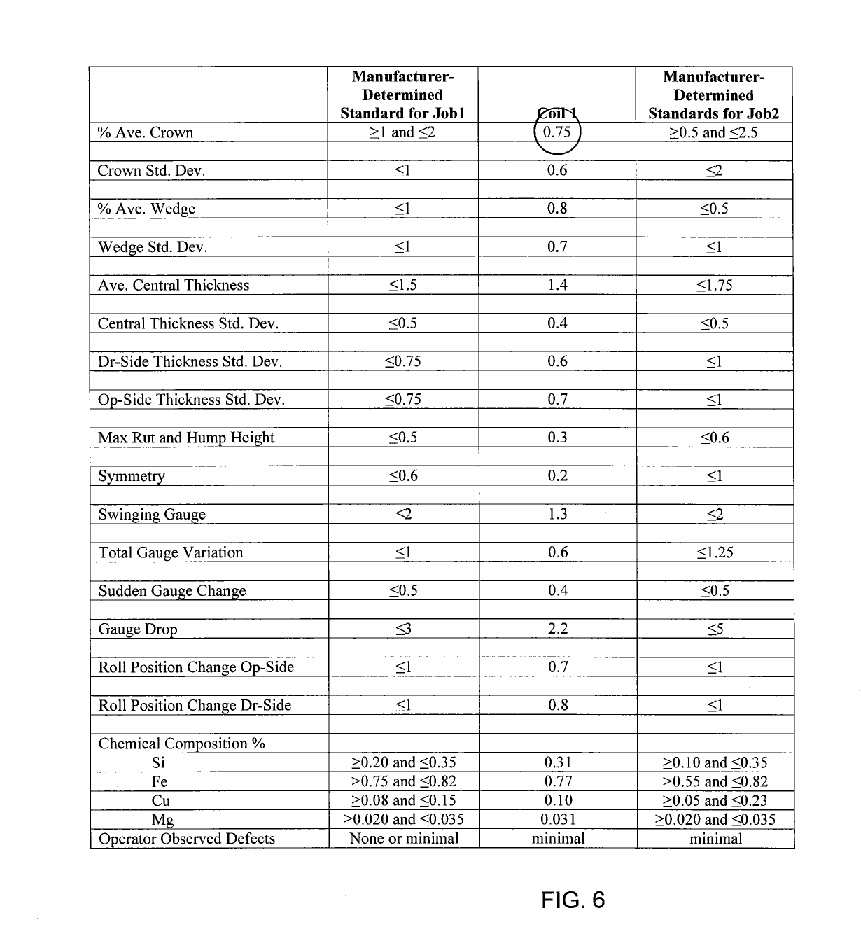

If a coil 16 is deemed inappropriate for use with a particular job, the system 10 may seek to match the coil for use with another job request. As shown in FIG. 2, the scheduler 36 may store all pending or anticipated job request 54 therein. FIG. 6 illustrates a case in which the cast coil (Coil1) does not meet the specifications for Job1, but does meet the specifications for Job2. Even though the coil may have been cast for Job1, the coil can thus be used for Job2. Since the scheduler 36 has stored therein, as shown in FIG. 2, the attributes and grades of various coils, as they are formed, and the attributes and specifications for various jobs 54, the scheduler 36 thereby has immediate access to the most up-to-date information relating to coils and jobs.

In this manner the system 10 enables flexible use and assignment of cast coils. Once a match between a job and coil or coils is made, the scheduler 36 may provide an output such that a worker, or other system, can access the coil and prepare the coil for further processing, as appropriate. The scheduler 36 may automatically match coils to job requests, or make suggestions to a human operator. For example, in one case the scheduler 36 may provide three suggested options, for use of a particular coil, to a human operator for selection by the operator.

The system 10/scheduler 36 may store and track any of a variety of inputs for the properties of the coils, jobs, etc. Thus, the list of inputs, properties, thresholds, standards, etc. shown herein is provided merely for illustrative purposes. The system 10 can be easily modified to account for various input and properties depending upon the particular parameters/characteristics of various casting machines 12 and other equipment. Because the system 10 is easily modified to account for differing quality criteria, the system 10 can be easily modified to differing casting machines, customer criteria, etc.

Besides providing the “matching” functionality specified herein, the scheduler 36 and tracking/observation system helps to improve efficiency of the casting process. For example, if the radiometer 38/caster roll sensor 34 notes a defect in the sheet 14/coil 16 that is occurring with a frequency related to the circumference of a roll 24, the system 10 or a user may deduce that a roll 24 has a defect in its shape. In addition, information from the spectrometer may be used to adjust the composition of the sheet 14 during the casting process.

The characteristics relating to the coil can be also used in later, downstream process of the sheet 14/coil 16. In particular, if any of the radiometer 38, caster roll 24, spectrometer 46 or observer 28 notes a particular defect, the defect can be provided as feedback to the casting machine 12, or an operator 28 thereof, to thereby adjust the casting operations. Thus, the observation/evaluation system provides immediate feedback such that casting operations can be improved by adjusting the operating parameters of the casting machine 12, making adjustments to the composition of the molten metal, etc., thereby improving efficiency and increasing yield.

In addition, knowing the properties of the coil 16 can help optimize and tailor further downstream processes, such as tempering, rolling and milling, to the particular qualities of the coil. For example, if a crack in the coil 16 is noted, or a particular area of thinning is noting, the cold mill operator can be notified. The mill operator can take into account such information when further processing the coil by, for example, slowing the speed of the cold rolling process or reducing tension in the cold rolling process to avoid breakage. In addition, since the specific location of the defect(s) can be tracked, the further processing of the coil 16 can be matched accordingly. For example, the cold rolling process may be slowed down only at the location where the portion of the coil 16 containing a defect is rolled, and the cold rolling process can then be resumed at full speed.

The system 10 also reduces customer rejections and increases customer satisfaction, since the system 10 can match the best coil 16 to the customer's order. The system 10 also increase the yield of post-casting processing (i.e. cold rolling or other steps). In particular, the system 10 can track or determine the best post-cast processing for that coil 16, thereby maximizing yield and minimizing scrap. The system 10 helps the casting company to determine the root cause of customer rejections, and any quality problems in the manufacturing processes after casting. The system 10 also can track some performance indicators of casting process.

The scheduler 36, ACCES system 35, and other components or systems (such as the LabVIEW™ system or the like) are shown and described herein as separate and discrete systems. However, if desired, such systems can be combined into a single computer, processor, microprocessor or the like (collectively termed “processor” herein), or spaced across multiple processors, and may include or be associated with a database for storing inputs about the coils, jobs, minimum and maximum parameters, etc. The scheduler 36, ACCES system 35, or other systems may also include, or take the form of, a block of software, code, or instructions which, when run on a processor, provide the desired functionality. The software which carries out the function and method disclosed herein can thus take the form of one or more computer readable and/or executable instructions that cause a processor or other electronic device to perform functions, actions and/or behave in a desired manner. Instructions may be embodied into various forms such as routines, algorithms, modules, methods, threads and/or programs. Thus, software can comprise and can take the form of computer-excludable instructions on a computer-readable medium.

Having described the invention in detail and by reference to certain embodiments, it will be apparent that modifications and variations thereof are possible without departing from the scope of the invention.

What is claimed is:

1. A method for evaluating a sheet comprising the steps of:
casting a sheet;
automatically determining characteristics relating to at least one of thickness or shape of the sheet during or immediately after the casting step;
automatically determining characteristics relating to the chemical composition of the sheet;
receiving an order for the sheet;
retrieving, from a database, specifications based upon the order; and
automatically comparing said determined characteristics to the retrieved specifications to determine the suitability of the sheet for use with the order.

2. The method of claim 1 wherein at least some of the specifications retrieved from said database are not included in the received order.

3. The method of claim 2 wherein said receiving step includes receiving information relating to an end use of the sheet, and where at least some of the specifications retrieved from the database are based upon the end use of the sheet.

4. The method of claim 2 wherein the specifications retrieved from said database that are not included in the received order includes specifications that relate to at least one of thickness or shape of the sheet.

5. The method of claim 1 further comprising the step of receiving specifications, from a customer, relating to said order, and wherein the retrieved specifications include more specifications than the received specifications.

6. The method of claim 1 further comprising the step of receiving specifications, from a customer, relating to said order, and wherein the retrieved specifications include at least one specification that relates to the same property but is different from the associated specification received from said customer.

7. The method of claim 1 further comprising the step of updating the database based upon feedback relating to the performance of the sheet in its end use.

8. The method of claim 1 wherein said receiving step takes place before said casting step.

9. The method of claim 1 further comprising the step of determining characteristics relating to visual properties of the sheet during or immediately after the casting step, and wherein the retrieving step includes retrieving specifications relating to visual properties of a sheet, and the comparing step includes comparing the determined visual property characteristics to the retrieved visual property specifications.

10. The method of claim 1 wherein the casting step includes passing the sheet through a pair of caster rolls, and wherein determining step includes measuring the position of the caster rolls or the size of a roll gap of the caster rolls.

11. The method of claim 1 wherein the first determining step includes determining the thickness of the sheet by a radiometer.

12. The method of claim 11 wherein the radiometer is movable across the surface of the sheet.

13. The method of claim 1 wherein said first determining step includes determining characteristics relating to the crown, wedge, thickness, rut height, hump height, symmetry, swinging gauge, total gauge variation, sudden gauge change and gauge drop of the sheet.

14. The method of claim 1 wherein said receiving, retrieving, and comparing steps are carried out by a processor, and wherein the results of the determining steps are provided to said processor.

15. The method of claim 14 wherein the comparing step results in a determination that the sheet is not acceptable for use with the order, and wherein the method further includes matching the sheet with an acceptable order.

16. The method of claim further 14 comprising the step of said processor assigning one of a plurality of grades to said sheet, and wherein said processor stores or accesses a plurality of thresholds of specifications therein for each grade, and wherein the characteristics of said sheet must meet or exceed each specification of a given grade to achieve that grade.

17. The method of claim 1 wherein the sheet is metal and the casting step includes forming the sheet from molten metal.

18. The method of claim 17 wherein said first determining step occurs before said cast sheet is first formed into a coil.

19. A method for evaluating a sheet comprising the steps of:
casting a metal sheet;
determining characteristics relating to the gauge of the sheet via gauge-measuring instrumentation which provides an output;
automatically processing said output of said gauge-measuring instrumentation to determine at least one of thickness or shape characteristics of said sheet;
receiving an order for the sheet;
retrieving, from a database, specifications based upon the order; and
comparing said determined characteristics to the retrieved specifications to determine the suitability of the sheet for use with the order.

20. The method of claim 19 further comprising the steps of determining characteristics relating to the chemical composition of the sheet, retrieving, from a database, specifications relating to chemical composition based upon the order, and comparing chemical composition characteristics to chemical composition specifications to determine the suitability of the sheet for use with the order.

21. A system for evaluating a sheet comprising:
a casting machine for casting a metal sheet;
a first sensor for determining characteristics relating to at least one of thickness or shape of the sheet during or immediately after the casting step;
a second sensor for determining chemical composition characteristics of the sheet; and
a processor configured to receive an order for the sheet, wherein the processor is configured to retrieve, from a database, specifications for the sheet based upon the order and compare the determined characteristics to the retrieved specifications to determine whether the sheet is acceptable for use with the order.

22. The system of claim 21 wherein said first sensor includes a caster roll sensor for sensing the thickness of said sheet as it is passed through a pair of caster rolls and a radiometer for sensing the thickness of said sheet, and wherein said second sensor includes a spectrometer for sensing the chemical composition the metal cast into the sheet.

23. The system of claim 21 further comprising the step of receiving an order for the sheet, wherein at least some of the specifications retrieved from said database are not included in the received order.

24. A method for evaluating a sheet of cast metal comprising the steps of:
determining at least one of thickness or shape characteristics of the sheet using radiometry;
determining at least one of thickness or shape characteristics of the sheet from a pair rolls through which the sheet is passed as it is formed;
determining characteristics of the composition of the sheet;
providing the results of the first, second and third determining steps to a processor; and
comparing, by the processor, the received results to the specifications for an order to determine the suitability of the sheet for use with the order.

25. The method of claim 24 wherein the comparing step includes retrieving, from a database, specifications based upon the order, and wherein at least some of the specifications retrieved from the database are based upon an end use of the sheet that is specified in or associated with the order.

26. The method of claim 24 further comprising the steps of determining characteristics relating to visual properties of the sheet during or immediately after the casting step, and providing the visual property results to the processor such that the processor considers the visual property results in the comparing step.

27. The method of claim 24 wherein the comparing step results in a determination that the sheet is not acceptable for use with the order, and wherein the method further includes matching the cast sheet with a different order.

28. The method of claim 24 wherein said first, second and third determining steps take place as or immediately after said sheet is cast and as said sheet is conveyed in a downstream direction away from a casting machine.
